(19) United States
(12) Patent Application Publication
(10) Pub. No.: US 2022/0098361 A1
(43) Pub. Date: Mar. 31, 2022

(54) RESIN COMPOSITION

(71) Applicant: SUMITOMO CHEMICAL COMPANY, LIMITED, Tokyo (JP)

(72) Inventors: Yuta KIKUCHI, Ichihara-shi (JP); Yusuke AIKYO, Tsukuba-shi (JP)

(21) Appl. No.: 17/427,432

(22) PCT Filed: Feb. 5, 2020
(86) PCT No.: PCT/JP2020/004247

§ 371 Date: Jul. 30, 2021

(30) Foreign Application Priority Data
Feb. 5, 2019 (JP) 2019-019007
Oct. 18, 2019 (JP) 2019-191071

(51) Int. Cl. C08G 63/183; C08K 3/40

(52) U.S. Cl. CPC C08G 63/183; C08K 3/40

(57) ABSTRACT

A resin composition including a thermoplastic resin and/or a thermosetting resin, and a glass component dispersed in the thermoplastic resin and/or the thermosetting resin, when a residue after ashing of the resin composition is subjected to an ICP analysis, a calcium content in the resin composition is 0% to 27% by mass with respect to 100% by mass of a metal content in the resin composition and a calcium content in the glass component is 0% to 27% by mass with respect to 100% by mass of the metal content in the glass component.

### TECHNICAL FIELD

The present invention relates to a resin composition. Priority is claimed on Japanese Patent Application No, 2019-019007, filed Feb. 5, 2019, and on Japanese Patent Application No. 2019-191071, filed Oct. 18, 2019, the contents of which are incorporated herein by reference.

### BACKGROUND ART

In the field of a dielectric device such as a resonator, a filter, an antenna, a circuit board, and a laminated circuit element hoard, in recent years, with the increase in the amount of information, the advancement of communication technology, and the depletion of the frequency band to he used, the use of a high-frequency band (centimeter wave to millimeter wave) has been promoted.

In general, an inorganic material tends to have a relatively low dielectric loss, but there is a problem in that it is difficult to reduce a relative permittivity. On the contrary, there are many organic materials having a low relative permittivity,

For this reason, a dielectric material configured by dispersing magnesium oxide fine particles, which are inorganic material particles, in a resin-based organic material has been proposed (Patent Document 1).

### CITATION LIST

### Patent Document

### Patent Document 1

Japanese Unexamined Patent Application, First Publication No, 2014-24916

### SUMMARY OF INVENTION

### Technical Problem

However, an attempt to reduce the dielectric properties of the relative permittivity and a dielectric loss tangent results in deterioration of the mechanical strength, and there is no known material that satisfies both the dielectric property and the mechanical strength.

The present invention has been made in view of the above circumstances, and aims to provide a resin composition having excellent mechanical strength, a small relative permittivity, and a small dielectric loss tangent.

### Solution to Problem

In order to solve the above problems, the present invention adopts the following configurations.

[1] A resin composition including a thermoplastic resin and/or a thermosetting resin, and a glass component dispersed in the thermoplastic resin and/or the thermosetting resin, wherein when a residue after asking of the resin composition is subjected to an ICP analysis, a calcium content in the resin composition is 0% to 27% by mass with respect to 100% by mass of a metal content in the resin composition.

[2] The resin composition according to [1], wherein when the residue after ashing of the resin composition is subjected to the ICP analysis, a silicon content in the resin composition is 51% by mass or more with respect to 100% by mass of the metal content in the resin composition.

[3] A resin composition including a thermoplastic resin and/or a thermoset resin, and a glass component dispersed in the thermoplastic resin and/or the thermosetting resin, in which a calcium content in the glass component is 0% to 27% by mass with respect to 00% by mass of a metal content in the glass component.

[4] The resin composition according to [3], in which a silicon content in the glass component is 51% by mass or more with respect to 100% by mass of the metal content in the glass component.

[5] The resin composition according to any one of [1] to [4], in which a relative permittivity εᵣ of the resin composition is 3.4 or less at a frequency of 1 GHz and a temperature of 25° C.

[6] The resin composition according to [5], in which a dielectric loss tangent tan δ of the resin composition is 5.5×10⁻³ or less at a frequency of 1 GHz and a temperature of 75° C.

[7] The resin composition according to [5] or [6], in which the resin composition has a thermal diffusivity of 0.14 mm²/s or more.

### Advantageous Effects of Invention

According to the present invention, a resin composition having excellent mechanical strength, a small relative permittivity, and a small dielectric loss tangent can be provided.

### Description of Embodiments

### <Resin Composition>

A resin composition of the present embodiment includes a thermoplastic resin and/or a thermosetting resin, and a glass component dispersed in the thermoplastic resin and/or the thermosetting resin.

The resin composition of the present embodiment can be obtained by mixing the thermoplastic resin and/or the thermosetting resin with the glass component and dispersing the glass component in the thermoplastic resin and/or thermosetting resin.

In the resin composition according the present embodiment, when a residue after asking of the resin composition is subjected to an ICP analysis, a calcium content in the resin composition is 0% to 27% by mass with respect to 100% by mass of a metal content in the resin composition. The calcium content in the resin composition is preferably 0% to 20% by mass, more preferably 0% to 15% by mass, and particularly preferably 0% to 10% by mass with respect to 100% by mass of the metal content in the resin composition. The calcium content in the resin composition may be 0.2% by mass or more, 0.4% by mass or more, or 1.0% by mass or more with respect to 100% by mass of the metal content in the resin composition. That is, the calcium content in the resin composition may be 0.2% to 20% by mass, 0.4% to 15% by mass, or 1.0% to 10% by mass with respect to 100% by mass of the metal content in the resin composition. When the calcium content in the resin composition is within the ranee described above, the resin composition of the present embodiment can have a small relative permittivity and a small dielectric loss tangent, and can also maintain the mechanical strength to the same extent as that of the composition containing the glass component of the same form.

In the present specification, the metal content refers to a component of a metal element, and here, the metalloids of boron, silicon, germanium, arsenic, antimony, tellurium, selenium, polonium, and astatine are included in the metal element. As the metal content of the glass component, Al, Ba, Ca, Si, Ti, Cd, Co, Cr, Cu, Fe, K, Li, Mg, Mn, Mo, Na, Ni, P, Pb, Sb, V, and Zn may be analyzed.

In the resin composition of the present embodiment, when the residue after aching of the resin composition is subjected to the ICP analysis, the calcium content in the resin composition is preferably 0% to 27% by mass, more preferably 0% to 20% by mass, still more preferably 0% to 15% by mass, and particularly preferably 0% to 10% by mass with respect to the total content of 100% by mass of Al, Ca, Si, K, Li, Mg, Na, and Zn in the resin composition. The calcium content in the resin composition may be 0.2% by mass or more, 0.4% by mass or more, or 1.0% by mass or more with respect to the total content of 100% by mass of Al, Ca, Si, K, Li, Mg, Na, and Zn in the resin composition. That is, the calcium content in the resin composition may be 0.2% to 20% by mass, 0.4% to 15% by mass, or 1.0% to 10% by mass with respect to the total content of 100% by mass of Al, Ca, Si, K, Li, Mg, Na, and Zn in the resin composition.

In the resin composition of the present embodiment, the calcium content in the glass component is 0% to 27% by mass, is preferably 0% to 20% by mass, more preferably 0% to 15% by mass, and particularly preferably 0% to 10% by mass with respect to 100% by mass of the metal content in the glass component. The calcium content in the glass component may be 0.2% by mass or more, 0.4% by mass or more, or 1.0% by mass or more with respect to 100% by mass of the metal content in the glass component. That is, the calcium content in the glass component may be 0.2% to 20% by mass, 0.4% to 15% by mass, or 1.0% to 10% by mass with respect to 100% by mass of the metal content in the glass component. When the calcium content in the class component is within the range described above, the resin composition of the present embodiment can have a small relative permittivity and a small dielectric loss tangent, and can also maintain the mechanical strength to the same extent as that of the composition containing the glass component of the same form.

In the resin composition of the present embodiment, the calcium content in the glass component is preferably 0% to 27% by mass, more preferably 0% to 20% by mass, still more preferably 0% to 15% by mass, and particularly preferably 0% to 1.0% by mass with respect to the total content of 100% by mass of Al, Ca, Si, K, Li, Mg, Na, and Zn in the glass component. The calcium content in the glass component may be 0.2% by mass or more, 0.4% by mass or more, or 1.0% by mass or more with. respect to 100% by mass of the metal. content in the glass component. That is, the calcium content in the glass component may be 0.2% to 20% by mass, 0.4% to 15% by mass, or 1.0% to 10% by mass with respect to 100% by mass of the metal content in the glass component. When the calcium content in the glass component is within the range described above, the resin composition of the present embodiment can have a small relative permittivity and a small dielectric loss tangent, and can also maintain the mechanical strength to the same extent as that of the composition containing the glass component of the same form.

In the resin composition of the present embodiment, when the residue after ashing of the resin composition is subjected to the ICP analysis, the silicon content in the resin composition is preferably 51% by mass or more, more preferably 55% by mass or more, and particularly preferably 60% by mass or more with respect to 100% by mass of the metal content in the resin composition. When the silicon content in the resin composition is within the range described above, the resin composition of the present embodiment can have a small relative permittivity and a small dielectric loss tangent, and can also maintain the mechanical strength to the same extent as that of the composition containing the glass component of the same form.

Further, in the resin composition of the present embodiment, when the residue after ashing of the resin composition is subjected to the ICP analysis, the silicon content in the resin composition is preferably 62% by mass or more, more preferably 65% by mass or more, and particularly preferably 70% by mass or more with respect to 100% by mass of the metal content in the resin composition. When the silicon content in the resin composition is within the range described above, the resin composition of the present embodiment can have a small relative permittivity, a small dielectric loss tangent, and a large thermal diffusivity, and can also maintain the mechanical strength to the same extent as that of the composition containing the glass component of the same form.

In the resin composition of the present embodiment, when the residue after ashing of the resin composition is subjected to the ICP analysis, the silicon content in the resin composition may be 100% by mass or less, 99.8% by mass or less, or 99.5% by mass or less with respect to 100% by mass of the metal content in the resin composition.

In the resin composition of the present embodiment, when the residue after ashing of the resin composition is subjected to the ICP analysis, the silicon content in the resin composition may be 51% by mass or more and 100% by mass or less, 55% by mass or more and 99.8% by mass or less, 60% by mass or more and 99.5% by mass or less, 62% by mass or more and 100% by mass or less, 65% by mass or more and 99.8% by mass or less, or 70% by mass or more and 99.5% by mass or less with respect to 100% by mass of the metal content in the resin composition.

In the resin composition of the present embodiment, when the residue after ashing of the resin composition is subjected to the ICP analysis, the silicon content in the resin composition is preferably 51% by mass or more, more preferably 55% by mass or more, and particularly preferably 60% by mass or more with respect to the total content of 100% by mass of Al, Ca, Si, K, Li, Mg, Na, and Zn in the resin composition.

Further, in the resin composition of the present embodiment, when the residue after ashing of the resin composition is subjected to the ICP analysis, the silicon content in the resin composition is preferably 62% by mass or more, more preferably 65% by mass or more, and particularly preferably 70% by mass or more with respect to the total content of 100% by mass of Al, Ca, Si, K, Li, Ma, Na, and Zn in the resin composition.

In the resin composition of the present embodiment, when the residue after asking of the resin composition is subjected to the ICP analysis, the silicon content in the resin composition may be 100% by mass or less, 99.8% by mass or less, or 99.5% by mass or less with respect to the total content of 100% by mass of Al, Ca, Si, K, Li, Mg, Na, and Zn in the resin composition.

In the resin composition of the present embodiment, then the residue after asking of the resin composition is subjected to the ICP analysis, the silicon content in the resin composition may be 51% by mass or more and 100% by mass or less, 55% by mass or more and 99.8% by mass or less, 60% by mass or more arid 99.5% by mass or less, 62% by mass or more and 100% by mass or less, 65% by mass or more and 99.8% by mass or less, or 70% by mass or more and 99.5% by mass or less with respect to the total content of 100% by mass of Al, Ca, Si, K, Li, Mg, Na, and Zn in the resin composition.

In the resin composition of the present embodiment, the silicon content in the glass component is preferably 51% by mass or more, more preferably 55% by mass or more, and particularly preferably 60% by mass or more with respect to 100% by mass of the metal content in the glass component. When the silicon content in the glass component is within the range described above, the resin composition of the present embodiment can have a small relative permittivity and a small dielectric loss tangent, and can also maintain the mechanical strength to the same extent as that of the composition containing the glass component of the same form.

Further, in the resin composition of the present embodiment, the silicon content in the glass component is preferably 62% by mass or more, more preferably 65% by mass or more, and particularly preferably 70% by mass or more with respect to 100% by mass of the metal content in the glass component.

When the silicon content in the glass component is within the range described above, the resin composition of the present embodiment can have a small relative permittivity, a small dielectric loss tangent, and a large thermal diffusivity, and can also maintain the mechanical strength to the same extent as that of the composition containing the glass component of the same form.

In the resin composition of the present embodiment, the silicon content in the glass component may be 100% by mass or less, 99.8% by mass or less, or 99.5% by mass or less with respect to 100% by mass of the metal content in the glass component.

In the resin composition of the present embodiment, the silicon content in the glass component may be 51% by mass or more and 100% by mass or less, 55% by mass or more and 99.8% by mass or less, 60% by mass or more and 99.5% by mass or less, 62% by mass or more and 100% by mass or less, 65% by mass or more and 99.8% by mass or less, or 70% by mass or more and 99.5% by mass or less with respect to 100% by mass of the metal content in the glass component.

In the resin composition of the present embodiment, the silicon content in the glass component is preferably 51% by mass or more, more preferably 55% by mass or more, and particularly preferably 60% by mass or more with respect to the total content of 100% by mass of Al, Ca, Si, K, Li, Mg, Na, and Zn in the glass component.

Further, in the resin composition of the present embodiment, the silicon content in the glass component is preferably 62% by mass or more, more preferably 65% by mass or more, and particularly preferably 70% by mass or more with respect to the total content of 100% by mass of Al, Ca, Si, K, Li, Mg, Na, and Zn in the glass component.

In the resin composition of the present embodiment, the silicon content in the glass component may be 99.8% by mass or less, 55% by mass or less, or 99.5% by mass or less with respect to the total content of 100% by mass of Al, Ca, Si, K, Li, Mg, and Zn in the glass component.

In the resin composition of the present embodiment, the silicon content in the glass component may be 51% by mass or more and 100% by mass or less, 55% by mass or more and 99.8% by mass or less, 60% by mass or more and 99.5% by mass or less, 62% by mass or more and 100% by mass or less, 65% by mass or more and 99.8% by mass or less, or 70% by mass or more and 99.5% by mass or less with respect to the total content of 100% by mass of Al, Ca, Si, K, Li, Mg, Na, and Zn in the glass component.

In the resin composition of the present embodiment, a relative permittivityεᵣ of the resin composition is preferably 3.4 or less, more preferably 3.35 or less, and particularly preferably 3.3 or less at a frequency of 1 GHz and a temperature of 25° C. When the relative permittivity εᵣ of the resin composition is equal to or less than the upper limit value described above, in the field of a dielectric device such as a resonator, a filter, an antenna, a circuit board, and a laminated circuit element board, a dielectric material that can be used for the use of a high-frequency band can be obtained.

The lower limit value of the relative permittivity εᵣ of the resin composition is not particularly limited, but may be 2.0 or more, 2.5 or more, or 3.0 or more.

That is, the relative permittivity εᵣ of the resin composition is preferably 2.0 or more and 3.4 or less, more preferably 2.5 or more and 3.35 or less, and particularly preferably 3.0 or more and 3.3 or less.

The relative permittivity εᵣ of the resin composition at a frequency of 1 GHz and a temperature of 25° C. can be measured by a method described in Examples by using a commercially available impedance analyzer by manufacturing a flat plate-shaped test piece from a target resin composition.

In the resin composition of the present embodiment, a dielectric loss tangent tan δ of the resin composition is preferably 5.5×0⁻³ or less, more preferably 5.0×10⁻³ or less, and particularly preferably 4.8×1.0⁻³ or less at a frequency of 1 GHz and a temperature of 25° C. The dielectric loss tangent tans of the resin composition being equal to or less than the upper limit value described above can suppress the dielectric loss and the transmission loss to a low level when the resin composition is used as the dielectric material of various dielectric devices.

The lower limit value of the dielectric loss tangent tan δ the resin composition is not particularly limited, but may be 4.0×10⁻³ or more, 4.3×10⁻³ or more, or 4.5×10⁻³ or more.

That is, the dielectric loss tangent tans of the resin composition is preferably 4.0×10⁻³ or more and 5.5×10⁻³ or less, more preferably 4.3×1.0⁻³ or more and 5.0×10⁻³ or less, and particularly preferably 4.5×10⁻³ or more and 4.8×10⁻³ or less.

The dielectric loss tangent tan δ of the resin composition at a frequency of 1 GHz and a temperature of 25° C. can be measured by a method described in Examples by using a commercially available impedance analyzer by manufacturing a flat plate-shaped test piece from the target resin composition.

The thermal diffusivity of the resin composition of the present embodiment is preferably 0.14 mm²/s s or more, more preferably 0.15 min²/s or more, and particularly preferably 0.16 mm²/s or more. The thermal diffusivity of the resin composition being equal to or more than the lower limit value can be easily released heat and can suppress the temperature rise to a low level when the resin composition is used as the dielectric material of various dielectric devices.

The upper limit value the thermal diffusivity of the resin composition is not particularly limited, but may be 0.25 mm²/s or less, 0.20 mm²/s or less, or 0.188 mm²/s or less.

That is, the thermal diffusivity of the resin composition is preferably 0.14 nm²/s or more and 0.25 mm²/s or less, more preferably 0.15 mm²/s or more and 0.20 mm²/s or less, and particularly preferably 0.16 mm²/s or more and 0.18 mm²/s or less.

The thermal diffusivity of the resin composition can be measured by a method described in Examples by using a commercially available thermal diffusivity meter by manufacturing a sheet-shaped test piece from the target resin composition.

(Thermoplastic Resin and/or Thermosetting Resin)

A matrix resin of the resin composition of the present embodiment may be the thermoplastic resin, the thermosetting resin, or a mixture of the thermoplastic resin and the thermosetting resin.

### Thermoplastic Resin

The thermoplastic resin may be a general-purpose plastic, an engineering plastic, or a super engineering plastic.

Specifically, general-purpose plastics such as polyethylene (PE), high-density polyethylene (HDPE), medium-density polyethylene (MDPE), low-density polyethylene (LDPE), polypropylene (PP), polyvinyl chloride (PVC), polyvinylidene chloride, polystyrene (PS), polyvinyl acetate (PVAc), polyurethane (PUR), polytetrafluoroethylene (PTFE), an acrylonitrile butadiene styrene resin (ABS resin), an AS resin, an acrylic resin. (PMMA), and the like; engineering plastics such as polyamide (PA), polyacetal (POM), polycarbonate (PC), modified polyphenylene ether (m-PPE, modified PPE, PPO), polyethylene terephthalate (PET), polybutylene terephthalate (PBT), cyclic polyolefin (COP), and the like; and super engineering plastics such as polyplienyiene sulfide (PPS), polytetrafluoroethylene (PTFE), polysulfone (PSF), polyethersulfone (PES), amorphous polyarylate (PAR), a liquid crystal polymer (LCP), polyetheretherketone (PEEK), thermoplastic polyimide (PI), polyaraide-imide (PAI), and the like, can be suitably used.

Among these, the liquid crystal polymer (LCP) is particularly preferable. The liquid crystal polymer (LCP) exhibits liquid crystallinity in a molten state, and it is preferable that the resin composition containing the liquid crystal polymer (LCP) also exhibit the liquid crystallinity in a molten state, and melt at a temperature of 450° C. or lower.

The liquid crystal polymer (LCP) used in the present embodiment may be liquid crystal polyester, liquid crystal polyester amide, liquid crystal polyester ether, liquid crystal polyester carbonate, or liquid crystal polyesterimide. As the liquid crystal polymer (LCP) used in the present embodiment, the liquid crystal polyester is preferable, and a wholly aromatic liquid crystal polyester formed of only an aromatic compound as a raw material monomer is particularly preferable.

Typical examples of the liquid crystal polyester used in the present embodiment include a product obtained by polymerizing (polycondensing) aromatic hydroxycarhoxylic acid, aromatic dicarboxylic acid, and at least one compound selected from the group consisting of aromatic diol, aromatic hydroxyamine, and aromatic diamine, a product obtained by polymerizing a plurality of types of aromatic hydroxycarboxylic acid, a product obtained by polymerizing aromatic dicarboxylic acid with at least one compound selected from. the group consisting of aromatic diol, aromatic hydroxyamine, and aromatic diamine, and a product obtained by polymerizing polyester such as polyethylene terephthalate with aromatic hydroxycarboxylic acid. Here, polymerizable derivatives of the aromatic hydroxycarboxylic acid, the aromatic dicarboxylic acid, the aromatic diol, the aromatic hydroxyamine, and the aromatic diamine may be each independently used in place of a part or all thereof.

Examples of the polymerizable derivative of the compound having a carboxy group such as the aromatic hydroxycarboxylic acid and the aromatic dicarboxylic acid include a product (ester) obtained by converting a carboxyl group into an alkoxycarbonyl group or an aryloxycarbonyl group, a product (acid halide) obtained by converting a carboxyl group into a haloformyl group, and a product (acid anhydride) obtained by converting a carboxyl group into an acyloxycarbonyl group. Examples of the polymerizable derivative of the compound having a hydroxyl group such as the aromatic hydroxycarboxylic acid, the aromatic diol, and the aromatic hydroxyamine include a product (acylated product) obtained by acylating a hydroxyl group and converting the acylated hydroxyl group into an acyloxyl group. Examples of the polymerizable derivative of the compound having an amino group such as the aromatic hydroxyamine and aromatic diamine include a product (acylated product) obtained by acylating an amino group and converting the acylated amino group into an acylamino group,

The liquid crystal polyester used in the present embodiment preferably has a repeating unit represented by the following formula (1) (hereinafter, may be referred to as “repeating unit (1)”), and more preferably has the repeating unit (1), a repeating unit represented by the following formula (2) (hereinafter, may be referred to as “repeating unit (2)”), and a repeating unit represented by the following formula (3) (hereinafter, may be refereed to as “repeating unit (3)”).

—O—Ar¹—CO— (1)

—CO—Ar²—CO— (2)

—X—Ar³—Y— (3)

(In the formulae (1) to (3), Ar¹ represents a phenylene group, a naphthylene group, or a biphenylylene group, and Ar² and Ar³ independently represent a phenylene group, a naphthylene group, a biphenylene group, or a group represented by the following formula (4). X and Y each independently represents an oxygen atom or an imino group. The hydrogen atoms in the groups represented by Ar¹, Ar², and Ar³ may be each independently substituted with a halogen atom, an alkyl group, or an aryl group.)

—Ar⁴—Z—Ar⁵— (4)

(In the formula (4), Ar⁴ and Ar⁵ each independently represents a phenylene group or a napInhylene group. Z represents an oxygen atom, a sulfur atom, a carbonyl group, a sulfonyl group, or an alkylidene group.)

It is preferable that the liquid crystal polyester used in the present embodiment include the repeating unit (1), the repeating unit (2), or the repeating unit represented by the repeating unit (3), the content of the repeating unit (1) be 30% by mol or more and 100% by mol or less with respect to the total amount of the repeating unit (1), the repeating unit (2), or the repeating unit (3), the content of the repeating unit (2) be 0% by mol or more and 35% by mol or less with respect to the total amount of the repeating unit (1), the repeating unit (2), or the repeating unit (3), and the content of the repeating unit (3) be 0% by mol or more and 35% by mol or less with respect to the total amount of the repeating unit (1), the repeating unit (2), or the repeating unit (3).

Examples of the halogen atom include a fluorine atom, a chlorine atom, a bromine atom, and an iodine atom. Examples of the alkyl group include a methyl group, an ethyl group, an n-propyl group, an isopropyl group, an n-butyl group, an isobutyl group, an s-butyl group, a t-butyl group, an n-hexyl group, a 2-ethylhexyl group, apt n-octyl group, and an n-decyl group, and the number of carbon atoms thereof is preferably 1 to 10. Examples of the aryl group include a phenyl group, an o-tolyl group, an m-tolyl group, a p-tolyl group, a 1-naphthyl group, and a 2-naphthyl group, and the number of carbon atoms thereof is preferably 6 to 20. When the hydrogen atom is substituted with these groups, the numbers thereof are each independently preferably 2 or less and more preferably 1 or less for each group represented by Ar¹, Ar², or Ar³.

Examples of the alkylidene group include a methylene group, an ethylidene, group, an isopropylidene group, an n-butylidene group, and a 2-ethylitexylidene group, and the number of carbon atoms thereof is preferably 1 to 10.

The repeating unit (1) is a repeating unit derived from a predetermined aromatic hydroxycarboxylic acid. As the repeating unit (1), a repeating unit in which Ar¹ is a p-phenylene group (repeating unit derived from p-hydroxybenzoic acid) and a repeating unit in which Ar¹ is a 2,6-naphthylene group (repeating unit derived from 6-hydroxy-2-naphthoic acid) are preferable.

In the present specification, the term “derived” means that the chemical structure of the functional group that contributes to the polymerization changes due to the polymerization of the raw material monomer, and no other structural change occurs.

The repeating unit (2) is a repeating unit derived from a predetermined aromatic dicarboxylic acid. As the repeating unit (2), a repeating unit in which Ar² is a p-phenylene group (repeating unit derived from terephthalic acid), a repeating unit in which Ar² is an m-phenylene group (repeating unit derived from isophthalic acid), a repeating unit in which Ar² is a 2,6-naphthylene group (repeating unit derived from 2,6-naphihalenedicarboxylic acid), and a repeating unit in which Ar² is a diphenylether-4,4′-diyl group (repeating unit derived from diphenylether-4,4′-dicarboxylic acid) are preferable.

The repeating unit (3) is a repeating unit derived. from a predetermined aromatic diol, aromatic hydroxylamine, or aromatic diamine. As the repeating unit (3), a repeating unit in which Ar³ is a p-phenylene group (repeating unit derived from hydroquinone, p-aminophenol, or p-pbenylenediamine) and a repeating unit in which Ar³ is a 4,4′-biphenytylene group (repeating unit derived from 4,4′.-dihydroxybiphenyl, 4-amino-4′-hydroxybiphenyl, or 4,4′-diaminobiphenyl) are preferable.

The content of the repeating unit (1) is preferably 30% by mot or more, more preferably 30% by mol or more and 80% by mol or less, still more preferably 40% by mol or more and 70% by mol or less, and particularly preferably 45% by mol or more and 65% by mol or less with respect to the total amount of all the repeating units (the total value of the amounts of substance equivalent (mol) of the repeating units obtained by dividing the mass of each repeating unit that configures the liquid crystal polyester resin by the formula weight of each repeating unit).

The content of the repeating unit (2) is preferably 35% by mol or less, more preferably 10% by mol or more and 35% by mol or less, still more preferably 15% by mol or more and 30% by mol or less, and particularly preferably 17.5% by mol or more and 27.5% by mol or less with respect, to the total amount of all the repeating units.

The content of the repeating unit (3) is preferably 35% by mol or less, more preferably 10% by mol or more and 35% by mol or less, still more preferably 15% by mol or more and 30% by mol or less, and particularly preferably 17.5% by mol or more and 27.5% by mol or less with respect to the total amount of all the repeating units.

The melt fluidity, the heat resistance, or the strength and rigidity is likely to be improved as the content of the repeating unit (1) becomes larger, but when the content is too large, the melting temperature or the melting viscosity is likely to increase and the temperature required for molding is likely to increase.

The ratio between the content of the repeating unit (2) and the content of the repeating unit (3) is represented by [content of repeating unit (2)]/[content of repeating unit (3)] (mol/mol), and is preferably 0.9/1 to 1/0.9, more preferably 0.95/1 to 1/0.95, and still more preferably 0.98/1 to 1/0.98.

The liquid crystal polyester used in the present embodiment may have two or more of the repeating units (1) to (3) independently. Further, the liquid crystal polyester may have a repeating unit other than the repeating units (1) to (3), and the content thereof is preferably 10% by mol or less and more preferably 5% by mol or less with respect to the total amount of all the repeating units.

The liquid crystal polyester used in the present embodiment preferably has, as the repeating unit (3), a repeating unit in which each of X and Y is an oxygen atom, that is, a repeating unit derived from a predetermined aromatic diol in that the melting viscosity is likely to be low, and more preferably has, as the repeating unit (3), only a repeating unit in which each of X and Y is an oxygen atom.

It is preferable that the liquid crystal polyester used in the present embodiment be manufactured by melt-polymerizing the raw material monomer corresponding to the repeating unit that configures the liquid crystal. polyester, and performing solid-phase polymerization on the obtained polymer (hereinafter, may be referred to as “prepolymer”). As a result, a high-molecular-weight liquid crystal polyester having a high heat resistance or high strength and rigidity can he manufactured with good operability. The melt polymerization. may be performed in the presence of a catalyst, and examples of the catalyst include a metal compound such as magnesium acetate, stannous acetate, tetrabutyl titanate, lead acetate, sodium acetate, potassium acetate, antimony trioxide, and the like or a nitrogen-containing heterocyclic compound such as 4-(dimethyiamino) pyridine, 1-methylimidazole, and the like, and a nitrogen-containing heterocyclic compound is preferably used.

The flow start temperature of the liquid crystal polyester used in the present embodiment is preferably 280° C. or higher, more preferably 280° C. or higher and 400° C. or lower, and still more preferably 280° C. or higher and 380° C. or lower.

The heat resistance, the strength, and the rigidity of the liquid crystal polyester tend to be improved as the flow start temperature of the liquid crystal polyester used in the present embodiment becomes higher. On the other hand, when the flow start temperature of the liquid crystal polyester exceeds 400° C., the inciting temperature and the melting viscosity of the liquid crystal polyester tend to increase. As a result, the temperature required for molding the liquid crystal polyester tends to increase.

In the present specification, the flow start temperature of the liquid crystal polyester is also called a flow temperature or a flowing temperature, and is a temperature that serves as a standard of the molecular weight of the liquid crystal polyester (see “Liquid Crystal Polymers-Synthesis/Molding/Application-” edited by Naoyuki Koide, CMC Publishing Co., Ltd., Jun. 5, 1987, p.95). The flow start temperature is a temperature indicating a viscosity of 4800 Pa·s (48000 poise) when the liquid crystal polyester is melted while raising the temperature at a rate of 4° C./min under a load of 9.8 MPa 1.100 kg/cm²) by using a capillary rheometer and extruded from a nozzle having an inner diameter of 1 mm and a length of 10 mm.

The content ratio of the liquid crystal polyester is preferably 80% by mass or more and 100% by mass or less with respect to 100% by mass of the thermoplastic resin. Examples of the resin other than liquid crystal polyester contained in the thermoplastic resin include the thermoplastic resin other than the liquid crystal polyester such as polypropylene, polyimide, polyester other than the liquid crystal polyester, polysulfone, polyphenylene sulfide, polyether ketone, polycarbonate, polyphenylene ether, polyetherimide, and the like.

### Thermosetting Resin

Examples of the thermoplastic resin include a phenol resin, a urea resin, a melamine resin, an unsaturated polyester resin, an epoxy resin, a silicone resin, and the like.

As the matrix resin of the resin composition of the present embodiment, the thermosetting resin may be used alone, or as a mixture with the thermoplastic resin.

### (Glass Component)

In the resin composition of the present embodiment, the dielectric property, the thermal diffusivity, and the mechanical strength of the resin composition can be adjusted by dispersing the glass component in a matrix resin of the thermoplastic resin and/or the thermosetting resin.

As the glass component used in the resin composition of the present embodiment, a fibrous glass filler, a flake-shaped glass filler, and a known filler containing a glass content, such as glass beads and a glass balloon, can be used, and the fibrous glass filler or the flake-shaped glass filler is preferable.

The weight-average fiber length. of the fibrous glass tiller is preferably 30 μm or more, more preferably 50 μm or more, and particularly preferably 80 μm or more. When the weight-average fiber length of the fibrous glass filler is equal to or more than the lower limit value, the mechanical strength can be made suitable. The number-average fiber length of the fibrous glass filler is preferably 30 μm or more, more preferably 50 μm or more, and particularly preferably 60 μm or more. When the number-average fiber length of the fibrous glass filler is equal to or more than the lower limit value, the mechanical strength can be made suitable.

The weight-average fiber length of the fibrous glass filler is preferably 300 μm or less, more preferably 150 μm or less, and particularly preferably 100 μm or less. When the weight-average fiber length of the fibrous glass filler is equal to or less than the upper limit value described above, molding is easy.

The number-average fiber length of the fibrous glass filler is preferably 300 μm or less, more preferably 150 μm or less, and particularly preferably 90 μm or less. When the number-average fiber length of the fibrous glass tiller is equal to or less than the upper limit value described above, molding is easy.

The weight-average fiber length of the fibrous glass filler is preferably 30 μm or more and 300 μm or less, more preferably 50 μm or more and 150 μm or less, and particularly preferably 80 μm or more and 100 μm or less.

The number-average fiber length of the fibrous glass filler is preferably 30 μm or more and 300 μm or less, more preferably 50 μm or more and 150 μm or less, and particularly preferably 60 μm or more and 90 μm or less.

The number-average fiber diameter of the fibrous glass filler is not particularly limited, but is preferably 1 to 40 μm more preferably 3 to 30 μm, still more preferably 5 to 20 μm, and particularly preferably 8 to 15 μm.

For the number-average fiber diameter of the fibrous glass filler, the number-average value of the values obtained by observing the fibrous glass filler with a scanning electron microscope (1000 times) and measuring the fiber diameters of 50 fibrous glass fillers is adopted.

When the number-average fiber diameter of the fibrous glass filler is equal to or more than the lower limit value of the preferable range described above, the fibrous glass filler is likely to be dispersed in the resin composition. In addition, the fibrous glass filler can be easily handled when the resin composition is manufactured. On the other hand, when the number-average fiber diameter thereof is equal to or less than the upper limit value of the preferable range described above, the mechanical strengthening of the resin composition by the fibrous glass filler can be efficiently carried out.

As the fibrous glass filler, a chopped glass fiber or a milled glass fiber is preferable. The chopped glass fiber is obtained by cutting a glass strand, and for example, a chopped glass fiber having a cut length of 3 to 6 mm and a fiber diameter of 9 to 13 μm is commercially available from Central Glass Co., Ltd. The milled glass fiber is obtained by pulverizing the glass fiber and has properties intermediate between those of the chopped glass fiber and powdered glass. For example, milled glass fibers having an average fiber length of 30 to 150 μm and a fiber diameter of 6 to 13 μm are commercially available from. Central Glass Co., Ltd.

The average particle diameter of the flake-shaped glass fillers is preferably 30 μm or more, more preferably 50 μm or more, and particularly preferably 80 μm or more. When the average particle diameter of the flake-shaped glass fillers is equal to or more than the lower limit value, the mechanical strength can be made suitable.

The average particle diameter of the flake-shaped glass fillers is preferably 300 μm or less, more preferably 200 μn or less, and particularly preferably 150 μm or less. When the average particle diameter of the flake-shaped glass fillers is equal to or less than the upper limit value described above, molding is easy.

The average particle diameter of the flake-shaped glass fillers is preferably 30 μm or more and 300 μm or less, more preferably 50 μm or more and 200 μm or less, and particularly preferably 80 μm or more and 150 μm or less.

The average thickness of the flake-shaped. glass fillers is preferably 0.2 μm or more, more preferably 0.5 μm or more, and particularly preferably 1.0 μm or more. When the average thickness of the flake-shaped glass fillers is equal to or more than the lower limit value, the mechanical strength can he made suitable.

The average thickness of the flake-shaped glass fillers is preferably 30 μm or less, more preferably 20 μm or less, and particularly preferably 10 μm or less. When the average thickness of the flake-shaped glass fillers is equal to or less than the upper limit value described above, molding is easy.

The average thickness of the flake-shaped glass fillers is preferably 0.2 μm or more and 30 μm or less, more preferably 0.5 μm or more and 20 μm or less, and particularly preferably 1.0 μm or more and 10 μm or less.

As the flake-shaped glass filler, for example, glass flakes having an average thickness of 2 to 5 μm and a particle diameter of 10 to 4000 μm, and fine flakes having an average thickness of 0.4 to 2.0 μm and a particle diameter of 10 to 4000 μm are commercially available from Nippon Sheet Glass Co., Ltd. The glass used for the glass flakes has a glass composition such as C glass, E glass, and the like.

The C glass contains an alkaline component and has high acid resistance. The E glass contains almost no alkaline and is highly stable in the resin.

Examples of the glass components n elude a glass fiber for an FRP reinforcing material, such as E glass (that is, non-alkaline glass), S glass, or T glass (that is, glass having high strength and high elasticity), C glass (that is, glass for acid-resistant applications), D glass (that is, glass having a low dielectric constant), ECR glass (that is, E glass substitute glass that does not contain B₂O₃ and F₂), AR glass (that is, glass for alkaline-resistant applications), and the like.

As the relative permittivity εᵣ of the glass component, a low dielectric constant is preferable, and the relative permittivity εᵣ of the glass component is preferably 4.80 or less, more preferably 4.30 or less, and particularly preferably 4.00 or less at a frequency of 1 GHz and a temperature of 25° C. The relative permittivity εᵣ of the glass component can be 3.00 or more, can be 3.10 or more, and can be 3.15 or more.

In the resin composition of the present embodiment, the content of the glass component is preferably 1% to 60% by mass, more preferably 10% to 50% by mass, and particularly preferably 20% to 40% by mass with respect to 100% by mass of the resin composition.

When the content of the glass component is equal to or more than the lower limit value of the preferable range described above, the adhesion between the thermoplastic resin and/or the thermosetting resin and the glass component is likely to be enhanced. On the other hand, when the content of the glass component is equal to or less than the upper limit value of the preferable range described above, the glass component can be easily dispersed.

### <Other Components>

If necessary, the resin composition of the present embodiment may contain, as the raw material, one or more other components such as a filler and an additive in addition to the thermoplastic resin and/or the thermosetting resin and the glass component. When the resin composition contains the thermosetting resin, the resin composition may contain a solvent.

The filler may be a plate-shaped filler, a spherical filler, or other granular fillers. Also, the filler may be an inorganic filler or an organic filler.

Examples of the plate-shaped inorganic filler include talc, mica, graphite, wollastonite, barium sulfate, and calcium carbonate. The mica may be potassium mica, phlogopite, fluorine phlogopite, or tetra, silicon mica.

Examples of the granular inorganic filler include silica, alumina, titanium oxide, boron nitride, silicon carbide, and calcium carbonate.

Examples of the additive include an antioxidant, a heat stabilizer, a UV absorber, art antistatic agent, a surfactant, a flame retardant, and a colorant.

### (Manufacturing Method of Resin Composition)

With the resin composition containing the thermoplastic resin of the present embodiment, a resin composition pellet can be obtained by, for example, mixing the thermoplastic resin, the glass component, and if necessary, other components to be melted and kneaded while being degassed by a twin-screw extruder, discharging a mixture of the obtained melt of the thermoplastic resin and the glass component in a strand shape via a circular nozzle (discharge port), and then pelletizing the discharged mixture by a strand cutter.

Further, for example, by mixing the thermosetting resin, the glass component, and if necessary, other components, the resin composition containing the thermosetting resin of the present embodiment can be obtained.

### (Molded Product)

With the resin composition of the present embodiment, a molded product can be obtained by a known molding method. As a method of molding the molded product from the resin composition containing the thermoplastic resin, a melt molding method is preferable, and examples thereof include an injection molding method, an extrusion molding method such as a T-die method and an inflation method, a compression molding method, a blow molding method, a vacuum molding method, and press molding. Among these, the injection molding method is preferable. Examples of a method of molding the molded product from the resin composition containing the thermosetting resin include an injection molding method and press molding. Among these, the injection molding method is preferable.

For example, when the molding is performed by using the resin composition containing the thermoplastic resin as the molding material by the injection molding method, the molding is performed by melting the resin composition by using a known injection molding machine, and injecting the resin composition containing the melted thermoplastic resin into a mold.

Examples of known injection molding machines include TR450EH3 manufactured by Sodick and PS40E5ASE type hydraulic horizontal molding machine manufactured by Nissei Plastic Industrial Co., Ltd.

The cylinder temperature of the injection molding machine is appropriately determined depending on the type of the thermoplastic resin, and is preferably set to a temperature of 10° C. to 80° C. higher than the flow start temperature of the thermoplastic resin to be used, for example, 300° C. to 400° C.

It is preferable that the temperature of the mold be set in the range of room temperature (for example, 23° C.) to 180° C. from the viewpoint of the cooling rate and productivity of the resin composition containing the thermoplastic resin.

For example, when the molding is performed by using the resin composition containing the thermosetting resin as the molding material by the injection molding method, the mold temperature is raised to 150° C. after the molding material is put into the mold by using a known injection molding machine. After the molding material is cured, the molded product can be extracted from the mold.

Further, the molded product of the present embodiment can be applied to applications of a dielectric device such as a resonator, a filter, an antenna, a circuit board, and a laminated circuit element board.

### EXAMPLES

The present invention will be described below in more detail with reference to specific examples. However, the present invention is not limited to the examples described below.

### <Glass Filler>

Glass fillers (A) to (F) shown in Table 1 below were prepares.

TABLE 1

| Glass filler | | (A) | (B) | (C) | (D) | (E) | (F) |
|---|---|---|---|---|---|---|---|
| Al | % by | 13.5 | 0.6 | 14.5 | 14.3 | 23.3 | 0.0 |
| | mass | | | | | | |
| Ca | % by | 34.4 | 1.4 | 29.4 | 28.3 | 7.4 | 0.0 |
| | mass | | | | | | |
| Si | % by | 49.5 | 91.7 | 48.3 | 50.0 | 60.8 | 99.3 |
| | mass | | | | | | |
| Ti | % by | 0.4 | 0.0 | 0.8 | 0.7 | 0.0 | 0.7 |
| | mass | | | | | | |
| Fe | % by | 0.0 | 0.0 | 0.6 | 0.7 | 0.0 | 0.0 |
| | mass | | | | | | |
| K | % by | 0.0 | 1.9 | 0.6 | 0.7 | 0.0 | 0.0 |
| | mass | | | | | | |
| Li | % by | 0.0 | 1.1 | 0.0 | 0.0 | 0.0 | 0.0 |
| | mass | | | | | | |
| Mg | % by | 1.5 | 0.6 | 5.3 | 5.0 | 2.9 | 0.0 |
| | mass | | | | | | |
| Na | % by | 0.6 | 2.8 | 0.4 | 0.4 | 0.0 | 0.0 |
| | mass | | | | | | |
| Zn | % by | 0.0 | 0.0 | 0.0 | 0.0 | 5.6 | 0.0 |
| | mass | | | | | | |
| Total | % by | 100.0 | 100.00 | 100.0 | 100.0 | 100.0 | 100.0 |
| | mass | | | | | | |
| Number- | μm | 119 | 76 | — | — | — | — |
| average | | | | | | | |
| fiber length | | | | | | | |
| Average fiber | μm | 11 | 8.1 | — | — | — | — |
| diameter | | | | | | | |
| Average | μm | — | — | 160 | 160 | 160 | 160 |
| particle | | | | | | | |
| diameter | | | | | | | |
| Average | μm | — | — | 0.7 | 5 | 1.3 | 5.0 |
| thickness | | | | | | | |

### <Number-Average Fiber Length of Raw Material Fibrous Glass Filler>

The raw material glass fillers (A) and (B) are the fibrous glass fillers (milled glass fibers) having the compositions shown in Table 1.

1.0 g of the raw material fibrous glass fillers was collected, dispersed in methanol and developed on a slide glass, microphotographs thereof were captured, the shapes of the fibrous glass fillers were directly read from the microphotographs, and the average value thereof was calculated to obtain the number-average fiber length of the fibrous glass filler. In calculation of the average value, the population parameter was set to 400 or more. Table 1 shows the results.

### <Average Thickness and Average Particle Diameter of Raw Material Flake-Shaped Glass Filler>

The raw material glass fillers (C) to (F) are the flake-shaped glass fillers having the compositions shown in Table 1.

The raw material flake-shaped glass fillers were observed with SEM at a magnification of 1000 times, the thicknesses and number-average particle diameters of 100 flake-shaped glass fillers randomly selected from the SEM image were measured, and the average value of the 100 measured values was calculated to obtain the average thickness and the number-average particle diameter of the raw material flake-shaped glass fillers. Table 1 shows the results.

20 parts by mass of the glass filler (D) and 10 parts by mass of the glass filler (F) were mixed to prepare a glass filler (G) shown in Table 2 below.

15 parts by mass of the glass filler (D) and 1.5 parts by mass of the glass filler (F) were mixed to prepare a glass filler (II) shown in Table 2 below.

7.5 parts by mass of the glass filler (D) and 22.5 parts by mass of the glass filler (F) were mixed to prepare a glass filler (I) shown in Table 2 below.

TABLE 2

| Glass filler | | (G) | (H) | (I) |
|---|---|---|---|---|
| Al | % by mass | 11.9 | 8.1 | 5.1 |
| Ca | % by mass | 22.0 | 15.5 | 9.5 |
| Si | % by mass | 59.3 | 71.9 | 82.7 |
| Ti | % by mass | 0.9 | 0.7 | 0.5 |
| Fe | % by mass | 0.2 | 0.0 | 0.0 |
| K | % by mass | 0.7 | 0.5 | 0.2 |
| Li | % by mass | 0.0 | 0.0 | 0.0 |
| Mg | % by mass | 4.6 | 3.0 | 1.9 |
| Na | % by mass | 0.4 | 0.2 | 0.0 |
| Zn | % by mass | 0.0 | 0.0 | 0.0 |
| Total | % by mass | 100.0 | 100.0 | 100.0 |

### <Manufacturing of Polymer>

### (1) Melt Polymerization

Into a reactor equipped with. a stirring device, a torque meter, a nitrogen gas introduction tube, a thermometer, and a reflux condenser, p-hydroxyhenzoic acid (994.5 g, 7.20 mol), terephthalic acid (272.1 g, 1.64 mol), isophthalic acid (126.6 g, 0.76 mol), 4,4′-dihydroxybiphenyl (446.9 g, 2.40 mol), and anhydrous acetic acid (347.6 g, 13.20 mol) were charged. After replacing the gas in the reactor with nitrogen gas, 0.18 g of 1-methylimidazole was added, the temperature was raised from room temperature to 150° C. over 30 minutes while stirring the mixture under a nitrogen gas stream, and the mixture was refluxed at 150° C. for 30 minutes.

Then, after adding 2.40 g of 1-methylimidazole. the temperature was raised from 150° C. to 320° C. over 2 hours and 50 minutes while distilling off the by-produced acetic acid and unreacted anhydrous acetic acid, the reaction was terminated when the increase in the torque was recognized, and the prepolymer of the contents was extracted from the reactor and cooled to room temperature.

### (2) Solid-Phase Polymerization

Next, solid-phase polymerization was performed in which this prepolymer was pulverized by using a pulverizer, and the obtained pulverized product was heated from room temperature to 250° C. over 1 hour in a nitrogen gas atmosphere, heated from 250° C. to 280° C. over 5 hours, and held at 280° C. for 3 hours. The obtained solid-phase polymer was cooled to room temperature to obtain a liquid crystal polyester (1).

The liquid crystal polyester (1) contained, with respect to the total ratio of all the repeating units, 60% by mol of a repeating unit (u12) in which Ar¹ is a 1,4-phenylene group, 13.65% by mol of a repeating unit (u22) which Ar² is a 1,4-phenylene group, 635% by mol of a repeating unit (u23) in which Ar² is a 1,3-phenylene group, and 20% by mol of a repeating unit (u32) in which Ar³ is a 4,4′-biphenylylene group in the molecule, and the flow start temperature thereof was 312° C.

### Comparative Example 1

### <Manufacturing of Pellet>

The liquid crystal polyester (1) was dried at 120° C. for 5 hours, 70 parts by mass of the liquid crystal polyester (1) and 30 parts by mass of the glass filler (A) were applied to a twin-screw extruder with a vacuum vent (“PCM-30” manufactured by IKEGAI), the mixture was degassed with the vacuum vent by using a water-sealed vacuum pump (“SW-25S” manufactured by Shinko Seiki Co., Ltd.), melted and kneaded under conditions of a cylinder temperature of 340° C. and a screw rotation speed of 150 rpm, and the kneaded product was discharged in a strand shape via a circular nozzle (discharge port) having a diameter of 3 mm. Next, the discharged kneaded product was passed through a water bath at a water temperature of 30° C. for 1.5 seconds, and then pelletized with a strand cutter (manufactured by Tanabe Plastic Machinery Co., Ltd.) to obtain a resin composition pellet (1) of Comparative Example 1 (pellet-shaped liquid crystal polyester resin composition (1)).

### Example 1

### <Manufacturing of Pellet>

A resin composition pellet (2) (pellet-shaped liquid crystal polyester resin composition (2)) of Example 1 was obtained in the same manner as in Comparative Example 1 except that 30 parts by mass of the glass filler (A) in Comparative Example 1 was changed to 30 parts by mass of the glass filler (B).

### Comparative Example 2

### <Manufacturing of Pellet>

A resin composition pellet (3) (pellet-shaped liquid crystal polyester resin composition (3)) of Comparative Example 2 was obtained in the same manner as in Comparative Example 1 except that 30 parts by mass of the glass filler (A) in Comparative Example 1 was changed to 30 parts by mass of the glass filler (C).

### Comparative Example 3

### <Manufacturing of Pellet>

A resin composition pellet (4) (pellet-shaped liquid crystal polyester resin composition (4)) of Comparative Example 3 was obtained in the same manner as in Comparative Example 1 except that 30 parts by mass of the glass filler (A) in Comparative Example 1 was changed to 30 parts by mass of the glass filler (D).

### Example 2

### <Manufacturing of Pellet>

A resin composition pellet (5) (pellet-shaped liquid crystal polyester resin composition (5)) of Example 2 was obtained in the same manner as in Comparative Example 1 except that 30 parts by mass of the glass tiller (A) in Comparative Example 1 was changed to 30 parts by mass of the glass filler (E).

### Example 31

### <Manufacturing of Pellet>

A resin composition pellet (6) (pellet-shaped liquid crystal polyester resin composition (6)) of Example 3 was obtained in the same manner as in Comparative Example 1 except that 30 parts by mass of the glass filler (A) in Comparative Example 1 was changed to 30 parts by mass of the glass tiller (F).

### Example 4

### <Manufacturing of Pellet>

A resin composition pellet (7) (pellet-shaped liquid crystal polyester resin composition (7)) of Example 4 was obtained in the same manner as in Comparative Example 1 except that 30 parts by mass of the glass filler (A) in Comparative Example 1 was changed to 30 parts by mass of the glass filler (G).

### Example 5

### <Manufacturing of Pellet>

A resin composition pellet (8) (pellet-shaped liquid crystal polyester resin composition (8)) of Example 5 was obtained in the same manner as in Comparative Example 1 except that 30 parts by mass of the glass filler (A) in Comparative Example 1 was changed to 30 parts by mass of the glass filler (H).

### Example 6

### <Manufacturing of Pellet>

A resin composition pellet (9) (pellet-shaped liquid crystal polyester resin composition (9)) of Example 6 was obtained in the same manner as in Comparative Example 1 except that 30 parts by mass of the glass filler (A) in Comparative Example 1 was changed to 30 parts by mass of the glass filler (I).

### <ICP Analysis/Test Item>

Test items were 22 elements of Al, Ba, Ca, Si, Ti, Cd, Co, Cr, Cu, K, Li, Mg, Mn, Mo, Na, Ni, P, Pb, Sb, V, and Zn.

### <ICP Analysis/Test Method>

### (Sample Heat Treatment)

The target sample of the resin composition pellet obtained in each of Examples and Comparative Examples was subjected to heat treatment at 600° C. for 6 hours to prepare a sample for analysis.

### (Al, Ba, Ca, Si, Ti)

The sample for analysis was heated and dissolved with an acid such as hydrofluoric acid or nitric acid, alkaline-melted with sodium carbonate, adjusted to a predetermined concentration with hydrochloric acid, and used as a test solution, and the test solution was measured by inductively coupled plasma emission spectrometry (ICP-AES). Table 3 and Table 4 show the analysis and test results. Ba was less than the detection limit (0.2% by mass).

### (Other 17 Items (Cd, Co, Cr, Cu, Fe, K, Li, Mg, Mn, Mo, Na, Ni, P, Ph, Sb, V, Zn))

The sample for analysis was heated and dissolved with an acid such as hydrofluoric acid or nitric acid, adjusted to a predetermined concentration, and used as a test solution, and the test solution was measured by inductively coupled plasma emission spectrometry (ICP-AES). Table 3 and Table 4 show the analysis and test results. All of Cd, Co, Cr, Cu, Mn, Mo, Ni, P, Pb, Sb, and V were less than the detection limit (0.2% by mass)

### (Measurement of Relative Permittivity and Dielectric Loss Tangent)

The resin composition pellets obtained in each Example and Comparative Example were vacuum dried at 120° C. for 5 hours, applied to PNX-40-5A (manufactured by Nissei Plastic Industrial Co., Ltd.) to manufacture a flat plate having a square of 64 mm and a thickness of 1.0 min under the molding condition of a cylinder temperature of 350° C. The relative permittivity and the dielectric loss tangent at 1 GHz of the obtained flat plate were measured under the following conditions.

measurement method: capacitive method (device: impedance analyzer (Agilent Technologies, Inc., model: E4991A))

electrode model: 16453 A

measurement environment: 23° C. 50% RH

applied voltage: 1 V

### (Measurement of Thermal Diffusivity)

The resin composition pellets obtained in each Example and Comparative Example were vacuum dried at 120° C. for 5 hours, applied to PNX-40-5A (manufactured by Nissei Plastic industrial Co., Ltd.), and a sheet having a square of 64 mm and a thickness of 1.0 min under the molding condition of a cylinder temperature of 350° C. was molded and cut into 10 mm×10 mm×1.0 mm to prepare a test piece. The thermal diffusivity of this test piece was measured by a laser flash method by using a thermal diffusivity meter “Nanoflash LFA457” (manufactured by Bruker Japan K. K.).

### (Tensile Test)

The resin composition pellets obtained in each Example and Comparative Example were vacuum dried at 120° C. for 5 hours, applied to PNX-40-5A (manufactured Nissei Plastic Industrial Co., Ltd.), and an ASTM No. 4 dumbbell test piece was subjected to injection molding under the molding condition of a cylinder temperature of 350° C. Tensile tests were performed on each of the 5 samples of this test piece at a crosshead rate of 10 mm/min by using a tensile tester Tensilon RTG-1250 (manufactured by A&D Company, Limited) in accordance with ASTM D638, the tensile strength and the elongation at the time of test were measured, and the average value thereof was obtained. Table 3 and Table 4 show the results.

### <Weight-Average Fiber Length and Number-Average Fiber Length of Fibrous Glass Filler in Resin Composition>

From each of the resin composition pellets obtained in Comparative Example I and Example 1, 1.0 g of the resin composition pellet was collected in a crucible, treated in an electric furnace at 600° C. for 4 hours, and ashed. The residue was dispersed in methanol and developed on a slide glass, microphotographs thereof were captured, the shapes of the fibrous glass fillers were directly read from the microphotographs, and the average value thereof was calculated to obtain the weight-average fiber length and the number-average fiber length of the fibrous glass filler in the resin composition. In calculation of the average value, the population parameter was set to 400 or more. The weight with respect to each fiber length was calculated from the specific gravity of the fibrous glass filler, and the weight-average fiber length was calculated by using the total weight of the samples having a population parameter of 400 or more as the denominator. Table 3 shows the results.

### <Average Thickness and Average Particle Diameter of Flake-Shaped Glass Filler in Resin Composition>

From each of the resin composition pellets obtained in Comparative Examples 2, 3 and Examples 2 to 6, 1.0 g of the resin composition pellet was collected in a crucible, treated in an electric furnace at 600° C. for 4 hours, and ashed, the residue thereof was dispersed in methanol, developed on a slide glass, observed with SEM at a magnification of 1000 times, the shapes of 100 flake-shaped glass fillers randomly selected from the SEM image were directly read, and the number-average value of maximum Feret diameters was calculated to obtain the number-average particle diameter of the flake-shaped glass fillers in the resin composition. Further, the number-average value of the thickness was calculated to obtain the average thickness of the flake-shaped glass fillers it the resin composition. In calculation of the average value, the population parameter was set to 400 or more. Table 3 and Table 4 show the results.

TABLE 3

| | | Comparative | | Comparative | Comparative | | |
|---|---|---|---|---|---|---|---|
| Resin composition | | Example 1 | Example 1 | Example 2 | Example 3 | Example 2 | Example 3 |
| pellet | | (1) | (2) | (3) | (4) | (5) | (6) |
| Al | % by | 13.5 | 0.6 | 14.5 | 14.3 | 23.3 | 0.0 |
| | mass | | | | | | |
| Ca | % by | 34.4 | 1.4 | 29.4 | 28.3 | 7.4 | 0.0 |
| | mass | | | | | | |
| Si | % by | 49.5 | 91.7 | 48.3 | 50.0 | 60.8 | 99.3 |
| | mass | | | | | | |
| Ti | % by | 0.4 | 0.0 | 0.8 | 0.7 | 0.0 | 0.7 |
| | mass | | | | | | |
| Fe | % by | 0.0 | 0.0 | 0.6 | 0.7 | 0.0 | 0.0 |
| | mass | | | | | | |
| K | % by | 0.0 | 1.9 | 0.6 | 0.7 | 0.0 | 0.0 |
| | mass | | | | | | |
| Li | % by | 0.0 | 1.1 | 0.0 | 0.0 | 0.0 | 0.0 |
| | mass | | | | | | |
| Mg | % by | 1.5 | 0.6 | 5.3 | 5.0 | 2.9 | 0.0 |
| | mass | | | | | | |
| Na | % by | 0.6 | 2.8 | 0.4 | 0.4 | 0.0 | 0.0 |
| | mass | | | | | | |
| Zn | % by | 0.0 | 0.0 | 0.0 | 0.0 | 5.6 | 0.0 |
| | mass | | | | | | |
| Total | % by | 100.0 | 100.0 | 100.0 | 100.0 | 100.0 | 100.0 |
| | mass | | | | | | |
| Relative | | 3.61 | 3.30 | 3.47 | 3.48 | 3.36 | 3.21 |
| permittivity | | | | | | | |
| (1 GHz) | | | | | | | |
| Dielectric | | 0.0053 | 0.0046 | 0.0055 | 0.0057 | 0.0053 | 0.0047 |
| loss tangent | | | | | | | |
| Thermal | mm²/s | 0.14 | 0.17 | 0.14 | 0.15 | 0.14 | 0.16 |
| diffusivity | | | | | | | |
| Tensile | MPa | 139 | 147 | 125 | 107 | 115 | 102 |
| strength | | | | | | | |
| Elongation | % | 3.4 | 3.0 | 2.1 | 2.9 | 2.1 | 3.2 |
| Weight- | μm | 121 | 94 | — | — | — | — |
| average | | | | | | | |
| fiber length | | | | | | | |
| Number- | μm | 84 | 75 | — | — | — | — |
| average | | | | | | | |
| fiber length | | | | | | | |
| Average fiber | μm | 11 | 8.1 | — | — | — | — |
| diameter | | | | | | | |
| Average | μm | — | — | 119 | 123 | 125 | 132 |
| particle | | | | | | | |
| diameter | | | | | | | |
| Average | μm | — | — | 0.5 | 4.4 | 1.1 | 4.6 |
| thiekness | | | | | | | |

TABLE 4

| | | Example 4 | Example 5 | Example 6 |
|---|---|---|---|---|
| Resin composition pellet | | (7) | (8) | (9) |
| Al | % by mass | 11.9 | 8.1 | 5.1 |
| Ca | % by mass | 22.0 | 15.5 | 9.5 |
| Si | % by mass | 59.3 | 71.9 | 82.7 |
| Ti | % by mass | 0.9 | 0.7 | 0.5 |
| Fe | % by mass | 0.2 | 0.0 | 0.0 |
| K | % by mass | 0.7 | 0.5 | 0.2 |
| Li | % by mass | 0.0 | 0.0 | 0.0 |
| Mg | % by mass | 4.6 | 3.0 | 1.9 |
| Na | % by mass | 0.4 | 0.2 | 0.0 |
| Zn | % by mass | 0.0 | 0.0 | 0.0 |
| Total | % by mass | 100.0 | 100.0 | 100.0 |
| Relative permittivity (1 GHz) | | 3.42 | 3.38 | 3.30 |
| Dielectric loss tangent | | 0.0055 | 0.0053 | 0.0051 |
| Thermal diffusivity | mm²/s | 0.15 | 0.16 | 0.16 |
| Tensile strength | MPa | 105 | 104 | 103 |
| Elongation | % | 4.6 | 4.7 | 4.9 |
| Average particle | μm | 126 | 128 | 131 |
| diameter | | | | |
| Average thickness | μm | 4.4 | 4.6 | 4.7 |

From the results shown in Table 3 and Table 4, the liquid crystal polyester resin composition of Example 1 to which the present invention is applied can have a small relative permittivity, a small dielectric loss tangent, and a large thermal diffusivity as compared with those of the liquid crystal polyester resin composition of Comparative Example 1. The mechanical strength was the same extent.

The liquid crystal polyester resin composition of Example 2 to which the present invention is applied can have a small relative permittivity and a small dielectric loss tangent as compared with those of the liquid crystal polyester resin compositions of Comparative Examples 2 and 3. The mechanical strength was the same extent.

The liquid crystal polyester resin compositions of Example 3 to 6 to which the present invention is applied can have a small relative permittivity, a small dielectric loss tangent, and a large thermal diffusivity as compared with those of the liquid crystal polyester resin compositions of Comparative Example 2 and 3. The mechanical strength was the same extent.

1. A resin composition, comprising:
a thermoplastic resin and/or a thermosetting resin; and
a glass component dispersed in the thermoplastic resin and/or the thermosetting resin,
wherein when a residue after ashing the resin composition is subjected to an ICP analysis, a calcium content in the resin composition is 0% to 27% by mass with respect to 100% by mass of a metal content in the resin composition.

2. The resin composition according to claim 1,
wherein when the residue after ashing the resin composition is subjected to the ICP analysis, a silicon content in the resin composition is 51% by mass or more with respect to 100% by mass of the metal content in the resin composition.

3. A resin composition, comprising:
a thermoplastic resin and/or a thermosetting resin; and
a glass component dispersed in the thermoplastic resin and/or the thermosetting resin,
wherein a calcium content in the glass component is 0% to 27% by mass with respect to 100% by mass of a metal content in the glass component.

4. The resin composition according to claim 3,
wherein a silicon content in the glass component is 51% by mass or more with respect to 100% by mass of the metal content in the glass component.

5. The resin composition according to claim 1,
wherein a relative permittivity εᵣ of the resin composition is 3.4 or less at a frequency of 1 GHz and a temperature of 25° C.

6. The resin composition according to claim 5,
wherein a dielectric loss tangent tans of the resin composition is 5.5×10⁻³ or less at a frequency of 1 GHz and a temperature of 25° C.

7. The resin composition according to claim 5,
wherein the resin composition has a thermal diffusivity of 0.14 mm²/s or more.

8. The resin composition according to claim 6,
wherein the resin composition has a thermal diffusivity of 0.14 mm²/s or more.

9. The resin composition according to claim 3,
wherein a relative permittivity εᵣ of the resin composition is 3.4 or less at a frequency of 1 GHz and a temperature of 25° C.

10. The resin composition according to claim 9,
wherein a dielectric loss tangent tans of the resin composition is 5.5×10⁻³ or less at a frequency of 1 GHz and a temperature of 25° C.

11. The resin composition according to claim 9,
wherein the resin composition has a thermal diffusivity of 0.14 mm²/s or more.

12. The resin composition according to claim 10,
wherein the resin composition has a thermal diffusivity of 0.14 mm²/s or more.
